(19) United States
(12) Patent Application Publication
(10) Pub. No.: US 2013/0208578 A1
(43) Pub. Date: Aug. 15, 2013

(54) MAGNETIC RECORDING MEDIUM AND MAGNETIC RECORDING AND REPRODUCING APPARATUS

(71) Applicant: SHOWA DENKO K.K., (US)

(72) Inventors: Tetsuya KANBE, Ichihara-shi (JP); Kazuya NIWA, Ichihara-shi (JP); Yuji MURAKAMI, Ichihara-shi (JP); Lei ZHANG, Ichihara-shi (JP)

(73) Assignee: SHOWA DENKO K.K., Tokyo (JP)

(21) Appl. No.: 13/764,144

(22) Filed: Feb. 11, 2013

(30) Foreign Application Priority Data
Feb. 14, 2012 (JP) 2012-029693

(51) Int. Cl. G11B 5/66

(52) U.S. Cl. CPC G11B 5/66
USPC 369/13.24; 428/829

(57) ABSTRACT

Disclosed is a magnetic recording medium having a structure in which at least an underlayer, a first magnetic layer and a second magnetic layer are sequentially stacked on a substrate, wherein the first magnetic layer includes an alloy having an L1ₒ structure as a main component, and wherein the second magnetic layer includes a non-crystalline alloy including Co as a main component and containing Zr of 6 to 16 atomic percent and at least one element of B and Ta.

### BACKGROUND OF THE INVENTION

1. Field of the Invention

The present invention relates to a magnetic recording medium used in a hard disk drive (HDD) or the like, and a magnetic recording and reproducing apparatus.

Priority is claimed on Japanese Patent Application No. 2012-029693, filed on Feb. 14, 2012, the content of which is incorporated herein by reference.

2. Description of Related Art

In recent years, the demand for a large capacity HDD has been gradually increased. In this regard, as a next-generation recording technique for remarkably enhancing a current recording capacity, thermally assisted recording has attracted attention.

Such thermally assisted recording is a technique of irradiating near-field light onto a magnetic recording medium, locally heating a surface thereof to temporally reduce coercivity of a magnetic layer, and then performing writing, and is capable of realizing a surface recording density of a class of 1 Tbit/inch².

As the magnetic recording medium (thermally assisted magnetic recording medium) used in such thermally assisted recording, a magnetic recording medium that uses an ordered alloy such as FePt alloy having an L1ₒ crystal structure or CoPt alloy having the same L1ₒ crystal structure in the magnetic layer may be used.

The ordered alloy having such an L1₀ crystal structure has high magneto crystalline anisotropy (Ku) of about 10⁶ J/m³, and is thus capable of providing a fine magnetic particle size of about 6 nm or less while maintaining thermal stability. Thus, it is possible to remarkably reduce medium noise while maintaining thermal stability.

Further, in order to divide crystalline particles formed of the ordered alloy, an oxide such as SiO₂ or TiO₂, C, BN or the like is added to the magnetic layer as a grain boundary phase material. In the thermally assisted magnetic recording medium, by using the magnetic layer having such a granular structure in which the magnetic crystalline particles are divided by the grain boundary phase material, it is possible to reduce exchange coupling between the magnetic particles and to achieve a high medium SNR.

Further, a technique has been proposed in which a magnetic layer magnetically and continuously coupled is stacked on the magnetic layer having such a granular structure to form a double-layer structure (refer to Japanese Unexamined Patent Application, First Publication No. 2009-158053, Japanese Unexamined Patent Application, First Publication No. 2008-159177, and Japanese Unexamined Patent Application, First Publication No. 2011-154746).

For example, Japanese Unexamined Patent Application, First Publication No. 2009-158053 discloses a double-layer structure in which a cap layer formed of CoCrPtB or FePt alloy is formed on a granular magnetic layer having FePt alloy as a main component. Further, JP-A-2008-159177 discloses a double-layer structure in which a non-crystalline magnetic layer formed of TbFeCo is formed on a granular magnetic layer formed of FePt alloy. Further, JP-A-2011-154746 discloses a double-layer structure in which a non-crystalline magnetic layer is formed on a granular magnetic layer.

In the magnetic layer having such a double-layer structure, as exchange coupling in a horizontal direction of a film surface is introduced, it is possible to reduce magnetic switching field distribution (SFD).

### SUMMARY OF THE INVENTION

The above-described magnetic layer having the granular structure in which the magnetic crystalline particles are divided by the grain boundary phase material has high Ku, and thus has favorable thermal stability. On the other hand, the SFD is extremely large, which obstructs enhancement of the medium SNR. In order to reduce the SFD, it is necessary to stack a magnetic layer magnetically and continuously coupled on the granular magnetic structure and to introduce uniform exchange coupling between particles of FePt alloy.

In order to solve the above problem, an object of the invention is to provide a magnetic recording medium that is capable of providing favorable thermal stability due to high Ku and a high medium SNR due to reduced SFD, and a magnetic recording and reproducing apparatus that includes the magnetic recording medium and is capable of reducing an error rate and increasing its capacity. The invention provides the following means.

(1) A magnetic recording medium having a structure in which at least an underlayer, a first magnetic layer and a second magnetic layer are sequentially stacked on a substrate, wherein the first magnetic layer includes an alloy having an L1₀ structure as a main component, and wherein the second magnetic layer includes a non-crystalline alloy containing Co as a main component and containing Zr of 6 to 16 atomic percent and at least one element of B and Ta.

(2) The magnetic recording medium according to (1), wherein the second magnetic layer includes a non-crystalline alloy of CoZrB, and B contained in the non-crystalline alloy is 6 to 16 atomic percent.

(3) The magnetic recording medium according to (2), wherein the sum of Zr and B contained in the non-crystalline alloy is 16 to 28 atomic percent.

(4) The magnetic recording medium according to (1), wherein the second magnetic layer includes a non-crystalline alloy of CoZrTa, and Ta contained in the non-crystalline alloy is 6 to 16 atomic percent.

(5) The magnetic recording medium according to (4), wherein the sum of Zr and Ta contained in the non-crystalline alloy is 16 to 28 atomic percent.

(6) The magnetic recording medium according to any one of (1) to (5), wherein the first magnetic layer includes FePt or CoPt alloy having the L1₀ structure as the main component, and includes at least one or more of SiO₂, TiO₂, Cr₂O₃, Al₂O₃, Ta₂O₅, ZrO₂, Y₂O₃, CeO₂, MnO, TiO, ZnO, C, B₂O₃ and BN.

(7) The magnetic recording medium according to any one of (1) to (6), wherein the first magnetic layer has a structure in which a lower magnetic layer that includes FePt alloy having the L1₀ structure as a main component and includes C and a upper magnetic layer that includes FePt alloy having the L1₀ structure as a main component and includes at least one or more of SiO₂, TiO₂, Cr₂O₃, Al₂O₃, Ta₂O₅, ZrO₂, Y₂O₃, CeO₂, MnO, TiO, ZnO, C, B₂O₃ and BN are sequentially stacked.

(8) A magnetic recording and reproducing apparatus including: the magnetic recording medium according to any one of (1) to (7); a medium driving unit that drives the magnetic recording medium in a recording direction; a magnetic head that includes a laser generating unit that heats the magnetic recording medium and a wave guiding path that guides laser light generated in the laser generating unit to a tip end portion, and performs a recording operation and a reproducing operation with respect to the magnetic recording medium; a head moving unit that relatively moves the magnetic head with respect to the magnetic recording medium; and a recording and reproducing signal processing system that performs signal input to the magnetic head and reproduction of an output signal from the magnetic head.

As described above, according to the invention, it is possible to achieve favorable thermal stability due to high Ku and to reduce the SFD, and thus, it is possible to achieve a high medium SNR. Thus, in the magnetic recording and reproducing apparatus including such a magnetic recording medium, it is possible to reduce an error rate and to increase its capacity.

### BRIEF DESCRIPTION OF THE DRAWINGS

FIG. 1 is a cross-sectional view illustrating a layer structure of a magnetic recording medium according to a first embodiment.

FIG. 2 is a perspective view illustrating a configuration of a magnetic recording and reproducing apparatus according to the first embodiment.

FIG. 3 is a cross-sectional view schematically illustrating a configuration of a magnetic head provided in the magnetic recording and reproducing apparatus shown in FIG. 2.

FIG. 4 is a cross-sectional view illustrating a layer configuration of a magnetic recording medium according to a fourth embodiment.

### DETAILED DESCRIPTION OF THE INVENTION

Hereinafter, a magnetic recording medium and a magnetic recording and reproducing apparatus according to an embodiment of the invention will be described in detail referring to the accompanying drawings.

In the following drawings, characteristics of the parts may be enlarged for ease of description in order to easily understand the characteristics, and the scale or the like of each component may not correspond to actual size. Further, materials, sizes or the like illustrated in the following description are only examples, and the invention is not necessarily limited thereto, and may be appropriately changed in a range without departing from the spirit of the invention.

The magnetic recording medium according to the present embodiment has a structure in which at least an underlayer, a first magnetic layer and a second magnetic layer are sequentially stacked on a substrate. Here, the first magnetic layer includes an alloy having an L1₀ structure as a main component, and the second magnetic layer includes a non-crystalline alloy containing Co as a main component and containing Zr and at least one element of B and Ta.

Specifically, it is preferable to use a heat-resistant glass substrate as the substrate. In the present embodiment, it is necessary to provide substrate heating at 600° C. or higher in a manufacturing process of the magnetic recording medium to be described later. Accordingly, it is preferable that the transition temperature of the glass substrate be 600° C. or higher. Further, as long as the transition temperature is 600° C. or higher, the substrate to be used may be a non-crystalline glass substrate or a crystalline glass substrate.

The underlayer is a layer for providing favorable (001) orientation to a magnetic layer formed on the underlayer in order to obtain a magnetic recording medium having high magneto crystalline anisotropy Ku. Further, it is preferable to use a layer obtained by stacking a plurality of underlayers as the underlayer. For example, a layer obtained by sequentially stacking a first underlayer, a second underlayer and a third underlayer may be used as the underlayer.

Here, it is preferable to use a non-crystalline alloy, as an adhesive layer, having favorable adhesion with the glass substrate in the first underlayer. By using the non-crystalline alloy as material of the first underlayer, it is possible to provide (100) orientation to the second underlayer. As a specific non-crystalline alloy used as material of the first underlayer, for example, NiTa, NiTi, CoTi, CrTi, TiAl or the like may be used. Further, there is no particular limitation to the non-crystalline alloy as long as it is a non-crystalline alloy.

On the other hand, it is possible to use NiAl or RuAl having a B₂ structure as material of the second underlayer. When the second underlayer is formed, it is preferable to perform substrate heating in which the substrate temperature is 200° C. or higher. Thus, it is possible to provide favorable (100) orientation to the second underlayer. Further, by providing the (100) orientation to the second underlayer, it is possible to provide the favorable (001) orientation to an L1₀ FePt alloy that forms the first magnetic layer (to be described later).

Further, it is possible to use Cr or a BCC structure alloy containing Cr as material of the second underlayer. Further, in a similar way to a case where NiAl or RuAl is used, it is preferable to perform substrate heating in which the substrate temperature is 200° C. or higher. As the BCC alloy used in the second underlayer, for example, CrMn, CrRu, CrV, CrTi, CrMo, CrW or the like may be used.

On the other hand, it is possible to use TiN as material of the third underlayer. By forming TiN on the second underlayer having the (100) orientation, it is possible to provide the (100) orientation to the TiN. Further, it is possible to use a material having a NaCl structure such as TiC, MgO, MnO or NiO, instead of TiN, as material of the third underlayer. Further, a material of a perovskite structure such as SrTiO₃ may be used as material of the third underlayer.

It is preferable that the third underlayer have low thermal conductivity. This is to prevent thermal diffusion from the magnetic layer to the underlayer and to easily increase the temperature of the magnetic layer when the magnetic layer is heated using near-field light generated from a head during recording. Here, in a case where the heating ability of the head is sufficiently high, the third underlayer may not be particularly formed.

It is preferable that the first magnetic layer include the L1₀ FePt alloy as a main component. By forming the first magnetic layer on the third underlayer having the (100) orientation, it is possible to provide the favorable (001) orientation to the L1₀ FePt alloy.

Further, when the first magnetic layer is formed, it is preferable to perform substrate heating in which the substrate temperature is 600° C. or higher. Thus, it is possible to obtain the L1₀ FePt alloy with a high degree of order. Further, in order to reduce the ordering temperature, Ag, Cu or the like may also be added to the FePt alloy.

On the other hand, the first magnetic layer may be a layer that includes an L1₀ CoPt alloy as a main component instead of the L1₀ FePt alloy. In this case, in a similar way to the L1₀ FePt alloy, it is possible to provide a favorable L1₀ degree of order and the (001) orientation to the CoPt alloy.

Further, it is preferable that the first magnetic layer include FePt or CoPt alloy having the L1₀ structure as a main component and have a granular structure in which magnetic crystalline particles are divided using a grain boundary phase material. Further, in order to magnetically divide the magnetic crystalline particles in the first magnetic layer, it is preferable that the first magnetic layer include at least one of SiO₂, TiO₂, Cr₂O₃, Al₂O₃, Ta₂O₅, ZrO₂, Y₂O₃, CeO₂, MnO, TiO, ZnO, C, B₂O₃ and BN.

Further, in order to sufficiently reduce exchange coupling between the magnetic particles, it is preferable that the content thereof is set to 20% or more by volume.

Further, the first magnetic layer may have a double-layer structure in which a lower magnetic layer that includes the FePt alloy having the L1₀ structure as a main component and includes C and an upper magnetic layer that includes the FePt alloy having the L1₀ structure as a main component and includes at least one or more of SiO₂, TiO₂, Cr₂O₃, Al₂O₃, Ta₂O₅, ZrO₂, Y₂O₃, CeO₂, MnO, TiO, ZnO, C, B₂O₃ and BN are sequentially stacked. As the first magnetic layer has the double-layer structure, it is possible to reduce particle size distribution and to obtain a high SNR.

It is possible to use a non-crystalline alloy that includes Co as a main component and includes Zr of 6 to 16 atomic percent and at least one element of B and Ta, in the second magnetic layer. By forming the second magnetic layer on the first magnetic layer, it is possible to reduce the magnetic switching field distribution (SFD).

Specifically, in order to reduce the SFD and to enhance the medium SNR, it is preferable that the second magnetic layer have high magnetization and the non-crystalline structure.

Here, since the second magnetic layer is formed immediately after the first magnetic layer is formed, it is considered that the substrate is not sufficiently cooled and maintains a high substrate temperature of about 500 to 550° C. or higher. Accordingly, it is necessary to use a material that is not crystallized at the substrate temperature in the second magnetic layer.

To this end, the second magnetic layer is formed of a CoZrB non-crystalline alloy. Here, Zr contained in the CoZrB non-crystalline alloy is 6 to 16 atomic percent, and B is preferably 6 to 16 atomic percent.

If the content of Zr and B is lower than 6 atomic percent, the CoZrB alloy is crystallized even at about 550° C., which is not preferable. On the other hand, if the content of Zr and B is higher than 16 atomic percent, magnetization is reduced and the reduction effect of the SFD is weakened, which is not preferable. Further, in order to suppress both the crystallization and the magnetization reduction, the sum of Zr and B contained in the CoZrB non-crystalline alloy is set to 16 to 28 atomic percent.

Further, instead of the CoZrB non-crystalline alloy, a CoZrTa non-crystalline alloy may be used as the second magnetic layer. In this case, in a similar way to the case of the CoZrB non-crystalline alloy, Zr contained in the CoZrTa non-crystalline alloy is 6 to 16 atomic percent, and preferably, and Ta is preferably 6 to 16 atomic percent. Further, the sum of Zr and Ta contained in the CoZrTa non-crystalline alloy is set to 16 to 28 atomic percent.

Further, a CoZrBTa non-crystalline alloy that includes both B and Ta may be used. In this case, the concentration of Zr is 6 to 16 atomic percent and the total concentration of B and Ta is preferably 6 to 16 atomic percent. If the concentration deviates from the above composition range, it is difficult to suppress both the crystallization and the magnetization reduction, which is not preferable.

Here, since it is necessary that the second magnetic layer be made of a magnetic continuous membrane, differently from the first magnetic layer, it is not necessary to add an oxide or a nitride to achieve a granular structure.

A protective layer is formed on the second magnetic layer. It is preferable to use a DLC film as the protective layer. The DLC film may be formed using a CVD method, an ion beam method or the like. Further, it is preferable that the thickness of the protective layer be 1 nm or more to 6 nm or less. If the thickness of the protective layer is smaller than 1 nm, a floating characteristic of the magnetic head deteriorates, which is not preferable. On the other hand, if the thickness of the protective layer is larger than 6 nm, magnetic spacing is increased to deteriorate the SNR, which is not preferable.

In the thermally assisted recording, if the cooling rate of the magnetic layer heated in recording is slow, a magnetization transition width is enlarged to deteriorate the SNR, and thus, it is necessary to rapidly cool the magnetic layer. Thus, it is preferable to provide a heat sink layer formed of a material having a high thermal conductivity in the magnetic recording medium according to the present embodiment. For example, Cu, Ag, Al, Au or an alloy using any one of these elements as a main component such as CuZr or AgPd may be used as the heat sink layer.

Further, in addition to the heat sink layer, in order to improve writing characteristic, a soft magnetic underlayer (SUL) or a plurality of underlayers for orientation control, particle size control or the like may be formed in the magnetic recording medium according to the present embodiment.

It is preferable that the heat sink layer and the soft magnetic underlayer be formed between the substrate and the first underlayer, which is not limitative as long as the (001) orientation of the magnetic layer does not considerably deteriorate. Further, there is no particular limitation with respect to the order of forming the heat sink layer and the soft magnetic underlayer.

In a case where the soft magnetic underlayer is formed, in order to increase a magnetic field gradient by narrowing the distance between the soft magnetic underlayer and the magnetic layer as much as possible, it is preferable to form the soft magnetic underlayer on an upper side (the side of the magnetic layer) of the heat sink layer. Here, in a case where the thickness of the heat sink layer is thin (about 50 nm or less), the SUL may be formed on a lower side (the side of the substrate) of the heat sink layer. In a case where the SUL is formed on the upper side of the heat sink layer, it is preferable to form an intermediate layer of about 1 to 30 nm between the soft magnetic underlayer and the magnetic layer to optimize the magnetic field gradient and magnetic field intensity.

Further, a non-crystalline alloy such as CoTaZr, CoTaNb, CoFeB, CoFeTaB, CoFeTaSi, or CoFeTaZr, a fine crystalline alloy such as FeTaC, FeTaB or FeTaN, a multi-crystalline alloy such as NiFe or the like may be used in the soft magnetic underlayer, for example. The soft magnetic underlayer may be a single-layer film made of the above-mentioned alloy, or may be a multi-layer film in which an Ru layer having an appropriate thickness is inserted for antiferromagnetic bonding.

As described above, in the magnetic recording medium, it is possible to obtain a high medium SNR due to a reduced SFD while maintaining favorable thermal stability due to high Ku. Accordingly, in the magnetic recording and reproducing apparatus using the magnetic recording medium, it is possible to reduce an error rate and to increase its capacity.

Further, when the thermally assisted recording is performed with respect to the magnetic recording medium, the surface is locally heated, and the coercivity of the magnetic layer is temporarily reduced to perform writing. In this case, it is possible to reduce the anisotropy field of the magnetic field, and thus, it is possible to easily perform recording even in an existing head magnetic field.

The magnetic recording medium according to the present embodiment is not limited to the thermally assisted recording. For example, it is possible to use the magnetic recording medium as a high frequency assisted magnetic recording medium that performs recording due to application of high frequency generated from a high frequency generating element mounted on a head. In the case of the high frequency assisted recording, it is possible to remarkably reduce the magnetic field of the magnetic layer due to application of the high frequency, and thus, it is possible to use a high Ku medium having excellent thermal stability, in a similar way to the case of thermally assisted recording.

### EXAMPLES

Hereinafter, effects of the invention will be more obvious referring to examples. The invention is not limited to the following examples, and may include appropriate modifications in a range without departing from the spirit of the invention.

### Example 1

### Examples 1-1 to 1-8

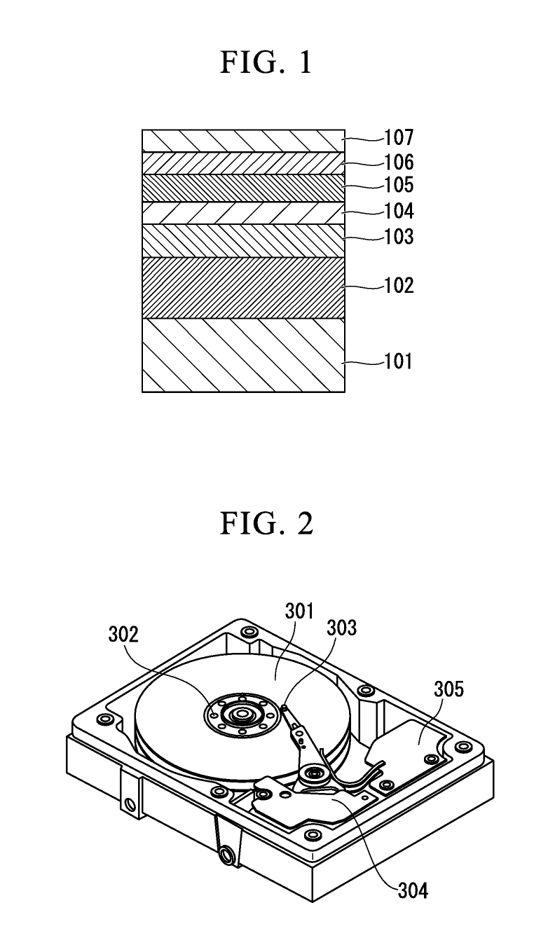

A layer structure of the magnetic recording medium manufactured in Example 1 is shown in FIG. 1.

When the magnetic recording medium shown in FIG. 1 was manufactured, first, a first underlayer 102 that includes Ni-50 at % Ta having a thickness of 35 nm was formed on a glass substrate 101 of 2.5 inches. Then, substrate heating was performed at 220° C., and a second underlayer 103 that includes Ru-50 at % Al having a thickness of 20 nm and a third underlayer 104 that includes TiN having a thickness of 3 nm were sequentially formed.

Next, after performing substrate heating at 600° C., a first magnetic layer 105 that includes (Fe 45 at % Pt-10 at % Ag)—15 mol % SiO₂ having a thickness of 12 nm and a second magnetic field 106 that includes CoZrB having a thickness of 3 nm were formed.

Here, in the second magnetic layer 106, the composition ratio of CoZrB was adjusted for formation in a range (numerical value range of the invention) where Zr is 6 to 16 at % and B is 6 to 16 at %.

Next, by forming a protective layer 107 that includes DLC having a thickness of 3 nm on the second magnetic layer 106, magnetic recording mediums of Examples 1-1 to 1-8 were manufactured.

### Comparative Examples 1-1 to 1-6

In Comparative Examples 1-1 to 1-5, with respect to the second magnetic layer 106, as shown in Table 1, the composition ratio of CoZrB was adjusted for formation so as to deviate from the numerical value range of the invention. Further, in Comparative Example 1-6, the second magnetic layer 106 was not formed. Except for this, the same magnetic recording mediums as those of Examples 1-1 to 1-8 were manufactured.

Further, with respect to the magnetic recording mediums of Examples 1-1 to 1-8 and Comparative Examples 1-1 to 1-6, coercivity Hc and normalized coercivity distribution ΔHc/Hc were measured. The measurement result is shown in Table 1.

TABLE 1

| | Second magnetic layer | Hc(kOe) | ΔHc/Hc |
|---|---|---|---|
| Example 1-1 | Co-6 at % Zr-7 at % B | 31.8 | 0.23 |
| Example 1-2 | Co-10 at % Zr-7 at % B | 34.1 | 0.25 |
| Example 1-3 | Co-13 at % Zr-8 at % B | 33.3 | 0.26 |
| Example 1-4 | Co-15 at % Zr-12 at % B | 33.3 | 0.27 |
| Example 1-5 | Co-8 at % Zr-12 at % B | 34.8 | 0.29 |
| Example 1-6 | Co-12 at % Zr-14 at % B | 34.6 | 0.27 |
| Example 1-7 | Co-13 at % Zr-15 at % B | 33.1 | 0.29 |
| Example 1-8 | Co-15 at % Zr-15 at % B | 33.5 | 0.30 |
| Comparative | Co-3 at % Zr-5 at % B | 30.1 | 0.22 |
| Example 1-1 | | | |
| Comparative | Co-5 at % Zr-10 at % B | 33.0 | 0.26 |
| Example 1-2 | | | |
| Comparative | Co-8 at % Zr-5 at % B | 32.0 | 0.27 |
| Example 1-3 | | | |
| Comparative | Co-18 at % Zr-12 at % B | 35.0 | 0.38 |
| Example 1-4 | | | |
| Comparative | Co-14 at % Zr-18 at % B | 31.0 | 0.35 |
| Example 1-5 | | | |
| Comparative | none | 38.9 | 0.55 |
| Example 1-6 | | | |

The coercivity Hc was measured at room temperature by application of a magnetic field of 7T using PPMS. Further, the ΔHc/Hc was measured using a method disclosed in “IEEE Trans. Magn., vol. 27, pp 4975-4977, 1991”.

Specifically, in a major loop and a minor loop, a magnetic field when the value of magnetization becomes 50% of a saturation value was measured, and assuming that magnetic switching field distribution is a Gaussian distribution from the difference therebetween, ΔHc/Hc was calculated. Here, ΔHc/Hc is a parameter corresponding to the half width of the magnetic switching field distribution. As the value is low, the SFD is narrowed, and thus, a favorable medium SNR is obtained.

As shown in Table 1, in the magnetic recording mediums of Examples 1-1 to 1-8, Hc in any case has a high value of 30 kOe or more. It can be understood that the L10-FePt alloy that forms the first magnetic layer 105 has a favorable degree of order in the magnetic recording mediums of Examples 1-1 to 1-8, from the measurement result.

Further, in the magnetic recording mediums of Examples 1-1 to 1-8, as the sum of Zr and B in CoZrB that forms the second magnetic layer 106 increases, ΔHc/Hc tends to increase, but ΔHc/Hc in any case has a low value of 0.3 or less.

On the other hand, in the magnetic recording mediums of Comparative Examples 1-1 to 1-6, Hc in any case has a high value of 30 kOe or more, but in the magnetic recording mediums of Comparative Examples 1-4 and 1-5, ΔHc/Hc is 0.35 or more, which shows a high value compared with the magnetic recording mediums of Examples 1-1 to 1-6. Particularly, in the magnetic recording medium of Comparative Example 1-6, ΔHc/Hc is 0.55, which is remarkably high. This shows that coercivity distribution is remarkably reduced as the second magnetic layer 106 is formed on the first magnetic layer 105.

Next, with respect to the magnetic recording mediums of Examples 1-1 to 1-8 and Comparative Examples 1-1 to 1-6, cross-sections thereof were observed using a high-resolution transmission electron microscopy. As a result, in the magnetic recording mediums of Examples 1-1 to 1-8, obvious lattice fringes in the second magnetic layer 106 were not observed. In this view, it can be considered that the CoZrB alloy that forms the second magnetic layer 106 has a non-crystalline structure, in any one of the magnetic recording mediums of Examples 1-1 to 1-8.

On the other hand, in the magnetic recording mediums of Comparative Examples 1-1 to 1-3 among the magnetic recording mediums of Comparative Examples 1-1 to 1-6, lattice fringes were partially observed in the second magnetic layer 106. It is considered this is because a region of a crystalline structure and a region of a non-crystalline structure are mixed in the second magnetic layer 106.

Next, a perfluoropolyether-based lubricant was coated on the surface of each magnetic recording medium of Examples 1-1 to 1-8 and Comparative Examples 1-1 to 1-6, and then, the magnetic recording medium was assembled in the magnetic recording and reproducing apparatus shown in FIG. 2.

As shown in FIG. 2, the magnetic recording and reproducing apparatus schematically includes a magnetic recording medium 301, a medium driving unit 302 for rotating the magnetic recording medium 301, a magnetic head 303 that performs a recording operation and a reproducing operation with respect to the magnetic recording medium 301, a head moving unit 304 that relatively moves the magnetic head 303 with respect to the magnetic recording medium 301, and a recording and reproducing signal processing system 305 that performs signal input to the magnetic head 303 and reproduction of an output signal from the magnetic head 303.

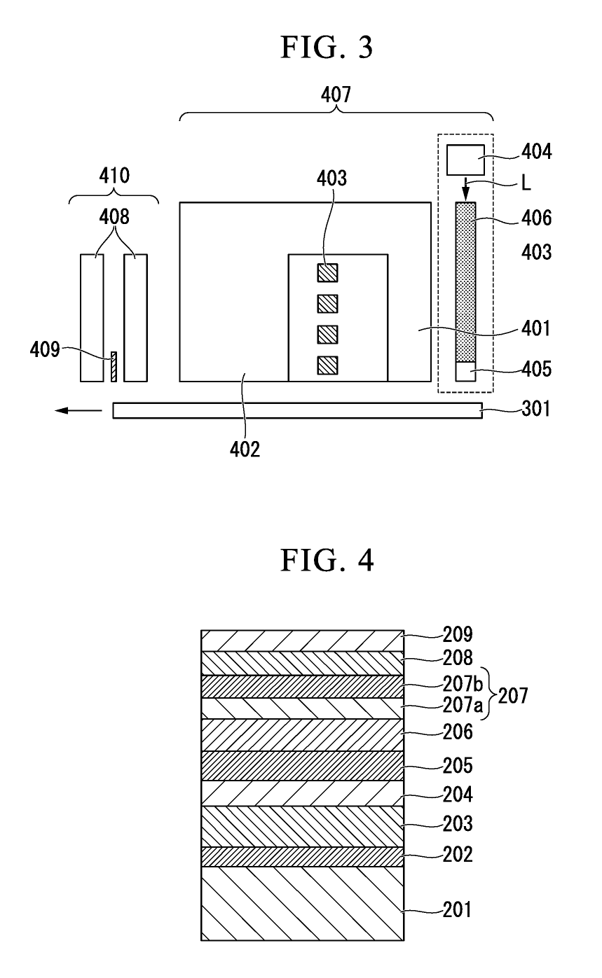

Further, a structure of the magnetic head 303 assembled in the magnetic recording and reproducing apparatus is schematically shown in FIG. 3. The magnetic head 303 schematically includes a recording head 407 that includes a main magnetic pole 401, an auxiliary magnetic pole 402, a coil 403 for generating a magnetic field, a laser diode (LD) (laser generating unit) 404, and a wave guiding path 406 for transmitting laser light L generated from the LD to a near-field generating element 405; and a reproducing head 410 that includes a pair of shields 408 and a reproducing element 409 such as a TMR element interposed between the pair of shields 408.

Further, in the magnetic recording and reproducing apparatus, near-field light generated from the near-field generating element 405 of the magnetic head 303 is irradiated onto the magnetic recording medium 301 to locally heat the surface, and thus, the coercivity of the first magnetic layer 105 is temporarily reduced to a head magnetic field to perform writing.

Further, in the magnetic recording and reproducing apparatus in which each magnetic recording mediums of Examples 1-1 to 1-8 and Comparative Examples 1-1 to 1-6 is assembled, a recording operation was performed under the condition of a track recording density of 1400 kFCI, and the signal to noise ratio (SNR) and the over writing (OW) characteristic were evaluated. The evaluation result is shown in Table 2. Electric power supplied to the LD 404 during recording was adjusted so that the recording track width defined as the half value width of a track profile is 70 nm.

TABLE 2

| | Second magnetic layer | SNR(dB) | OW(dB) |
|---|---|---|---|
| Example 1-1 | Co-6 at % Zr-7 at % B | 12.3 | 28.1 |
| Example 1-2 | Co-10 at % Zr-7 at % B | 13.4 | 25.5 |
| Example 1-3 | Co-13 at % Zr-8 at % B | 13.3 | 26.7 |
| Example 1-4 | Co-15 at % Zr-12 at % B | 13.8 | 25.3 |
| Example 1-5 | Co-8 at % Zr-12 at % B | 13.4 | 25.1 |
| Example 1-6 | Co-12 at % Zr-14 at % B | 13.1 | 27.1 |
| Example 1-7 | Co-13 at % Zr-15 at % B | 12.4 | 25.5 |
| Example 1-8 | Co-15 at % Zr-15 at % B | 12.1 | 26.1 |
| Comparative | Co-3 at % Zr-5 at % B | 8.1 | 22.1 |
| Example 1-1 | | | |
| Comparative | Co-5 at % Zr-10 at % B | 8.7 | 20.6 |
| Example 1-2 | | | |
| Comparative | Co-8 at % Zr-5 at % B | 9.5 | 22.7 |
| Example 1-3 | | | |
| Comparative | Co-18 at % Zr-10 at % B | 8.1 | 19.1 |
| Example 1-4 | | | |
| Comparative | Co-14 at % Zr-18 at % B | 7.7 | 17.7 |
| Example 1-5 | | | |
| Comparative | none | 5.5 | 20.6 |
| Example 1-6 | | | |

As shown in Table 2, in the magnetic recording and reproducing apparatus in which each magnetic recording medium of Examples 1-1 to 1-8 is assembled, a high SNR of 12 dB or higher and a favorable OW characteristic of 25 dB or higher were obtained in any case. Particularly, in the magnetic recording and reproducing apparatuses of Examples 1-2 to 1-6, the SNR showed high values of 13 dB or higher. It is considered that this was because the coercivity distribution was reduced.

On the other hand, in the magnetic recording and reproducing apparatus in which each magnetic recording medium of Comparative Examples 1-1 to 1-6 is assembled, in any case, the SNR showed low values of 10 dB or lower and the OW characteristic also showed low values of 23 dB or lower. Here, in the magnetic recording mediums of Comparative Examples 1-1 to 1-3, it is considered that the reason why the coercivity distribution (ΔHc/Hc) showed low values of 0.3 or lower but the SNR was remarkably reduced is that the crystalline region and the non-crystalline region were mixed in the second magnetic layer 106.

As described above, it can be understood that in the magnetic recording medium using the second magnetic layer 106 that includes the CoZrB non-crystalline alloy in which Zr contained in the CoZrB non-crystalline alloy is 6 to 16 atomic percent and B contained therein is 6 to 16 atomic percent, it is possible to remarkably improve the SNR.

In the magnetic recording mediums of Examples 1-2 to 1-6, particularly, the SNR showed high values of 13 dB or higher. Thus, it can be understood that as the sum of Zr and B contained in the second magnetic layer (CoZrB) 106 is in the range of 16 to 28 at %, a magnetic recording medium having a high SNR is particularly obtained.

### Example 2

### Examples 2-1 to 2-5

In Example 2, the same magnetic recording mediums as that of Example 1-3 were manufactured, except that the first magnetic layer 105 shown in FIG. 1 had a double-layer structure of a lower magnetic layer and an upper magnetic layer. Further, the lower magnetic layer was formed of (Fe-50 at % Pt)-45 at % C with a thickness of 5 nm. On the other hand, the upper magnetic layer was formed of (Fe-50 at % Pt)-15 mol % SiO₂ (Example 2-1), (Fe-50 at % Pt)-12 mol % TiO₂ (Example 2-2), (Fe-50 at % Pt)-12 mol % B₂O₃ (Example 2-3), (Fe-50 at % Pt)-10 mol % C-12 mol % SiO₂ (Example 2-4), and (Fe-50 at % Pt)-20 mol % C-10 mol % BN (Example 2-5), with a thickness of 5 nm, respectively.

Further, in the magnetic recording and reproducing apparatus in which each magnetic recording medium of Examples 2-1 to 2-5, the SNR and the OW characteristics were evaluated under the same conditions as those of Example 1. The evaluation result is shown in Table 3.

TABLE 3

| | Upper magnetic layer | SNR (dB) | OW(dB) |
|---|---|---|---|
| Example 2-1 | (Fe-50 at % Pt)-15 mol % SiO₂ | 13.8 | 32.5 |
| Example 2-2 | (Fe-50 at % Pt)-12 mol % TiO₂ | 14.1 | 33.5 |
| Example 2-3 | (Fe-50 at % Pt)-12 mol % B₂O₃ | 13.9 | 36.1 |
| Example 2-4 | (Fe-50 at % Pt)-10 mol % | 14.2 | 39.5 |
| | C-12 mol % SiO₂ | | |
| Example 2-5 | (Fe-50 at % Pt)-20 mol % | 13.7 | 34.1 |
| | C-10 mol % BN | | |

As shown in Table 3, in the magnetic recording and reproducing apparatus in which each magnetic recording medium of Examples 2-1 to 2-5 is assembled, an SNR higher than that of the magnetic recording and reproducing apparatus of Example 1-3 and a favorable OW characteristic of 32 dB or higher were obtained in any case. Particularly, the magnetic recording and reproducing apparatus of Example 2-4 showed the highest OW characteristic.

Further, with respect to the magnetic recording and reproducing apparatuses, Examples 2-1 to 2-5, ΔHc/Hc was measured under the same conditions as those of Example 1. In any case, ΔHc/Hc showed a low value of 0.24 or less. Here, it is considered that the reason why the magnetic recording and reproducing apparatuses of Example 2-1 to 2-5 showed SNRs higher than that of the magnetic recording and reproducing apparatus of Example 1-3 is that ΔHc/Hc was further reduced.

As described above, it can be understood that as the first magnetic layer 105 has the double-layer structure, it is possible to further improve the SNR and OW characteristics.

### Example 3

### Examples 3-1 to 3-5

In Example 3, the same magnetic recording mediums as that of Example 1-4 were manufactured, except that the second magnetic layer 106 shown in FIG. 1 was formed of Cr-10 at % Mn (Example 3-1), Cr-20 at % Ru (Example 3-2), Cr-40 at % Mo (Example 3-3), Cr-15 at % Ti (Example 3-4), and Cr-50 at % V (Example 3-5), with a thickness of 10 nm, respectively.

Further, in the magnetic recording and reproducing apparatus in which each magnetic recording medium of Examples 3-1 to 3-5 is assembled, the SNR and OW characteristics were evaluated under the same conditions as those of Example 1. The evaluation result is shown in Table 4.

TABLE 4

| | Second underlayer | SNR (dB) | OW(dB) |
|---|---|---|---|
| Example 3-1 | Cr-10 at % Mn | 14.3 | 27.7 |
| Example 3-2 | Cr-20 at % Ru | 14.7 | 26.8 |
| Example 3-3 | Cr-40 at % Mo | 15.1 | 29.1 |
| Example 3-4 | Cr-15 at % Ti | 15.3 | 27.1 |
| Example 3-5 | Cr-50 at % V | 14.5 | 28.8 |

As shown in Table 4, in the magnetic recording and reproducing apparatus in which each magnetic recording medium of Examples 3-1 to 3-5 is assembled, in any case, an SNR higher than that of the magnetic recording and reproducing apparatus of Example 1-4 by about 0.5 to 1.5 dB and a favorable OW characteristic of 26 dB or higher were obtained.

Further, measurement was performed using X-ray diffraction with respect to the magnetic recording mediums of Examples 3-1 to 3-5. Here, only a BBC (200) peak was observed from the second underlayer 103 of every magnetic recording medium. Further, a L1₀-FePt (001) peak, and a mixed peak of a L1₀-FePt (002) peak and an FCC—FePt (200) peak were only observed from the first magnetic layer 105. In the magnetic recording mediums of Examples 3-1 to 3-5, it is considered that the L1₀-FePt alloy that forms the first magnetic layer 105 has a favorable degree of order while using the (001) orientation, from the measurement result.

Further, the third underlayer 104 showed a thin thickness of 3 nm and a clear peak was not observed, whereas the first magnetic layer 105 showed a favorable (001) orientation. In this view, it is considered that the third underlayer 104 was subject to epitaxial growth on the second underlayer 103 to have the (100) orientation.

Further, the ratio I₀₀₁/(I₀₀₂+I₀₀₂) of the intensity I₀₀₁ of the L1₀-FePt (001) peak to the intensity (I₀₀₂+I₂₀₀) of the mixed peak of the L1₀-FePt (002) peak and the FCC—FePt (200) peak showed a high value of 2.4 or higher in any case. On the other hand, the peak intensity ratio was 2.1 with respect to the magnetic recording medium of Example 1-4. In this view, it can be understood that in the magnetic recording mediums of Examples 3-1 to 3-5, the L1₀-FePt alloy that forms the first magnetic layer 105 has a favorable degree of order compared with the magnetic recording medium of Example 1-4.

Further, it is considered that the reason why the magnetic recording mediums of Examples 3-1 to 3-5 showed SNRs higher than that of the magnetic recording medium of Example 1-4 is that the degree of order of L1₀ -FePt alloy was improved by using a Cr alloy having a BCC structure in the second magnetic layer 103.

### Example 4

### Examples 4-1 to 4-8

A layer structure of a magnetic recording medium manufactured in Example 4 is shown in FIG. 4.

When the magnetic recording medium shown in FIG. 4 is manufactured, first, an adhesive layer 202 that includes Cr-50 at % Ti having a thickness of 5 nm was formed on a glass substrate 201 of 2.5 inches, and then, a heat sink layer 203 that includes Ag-7 at % Pd having a thickness of 50 nm was formed. Further, a first underlayer 204 that includes Ni-38 at % Ta having a thickness of 5 nm was formed, substrate heating was performed at 280° C., and then, a second underlayer 205 that includes Cr-10 at % Ti having a thickness of 20 nm and a third underlayer 206 that includes TiC having a thickness of 2 nm were sequentially formed.

Next, after performing substrate heating at 640° C., a first magnetic layer 207 having a double-layer structure that includes a lower magnetic layer 207a that includes (Fe 45 at % Pt-10 at % Ag)-35 mol % C having a thickness of 6 nm and an upper magnetic layer 207b that includes (Fe 45 at % Pt-10 at % Ag)-10 mol % SiO₂-10 mol % BN having a thickness of 4 nm, and a second magnetic layer 208 having a thickness of 4 nm were formed.

Here, in the second magnetic layer 208, the composition ratio of CoZrTa was adjusted for formation in a range (numerical value range of the present embodiment) where Zr is 6 to 16 at % and Ta is 6 to 16 at %.

Next, a protective layer 209 that includes DLC having a thickness of 3 nm was formed on the second magnetic layer 208, and thus, magnetic recording mediums of Examples 4-1 to 4-8 were manufactured.

### Comparative Examples 4-1 to 4-6

In Comparative Examples 4-1 to 4-6, as shown in Table 5, the composition ratio of CoTaB was adjusted for formation so as to deviate from the numerical value range of the present embodiment with respect to the second magnetic layer 208. Except for this, the same magnetic recording mediums as those of Examples 4-1 to 4-8 were manufactured.

Further, each magnetic recording medium of Examples 4-1 to 4-8 and Comparative Examples 4-1 to 4-5 was assembled with the magnetic recording and reproducing apparatus shown in FIG. 2. Further, the magnetic recording and reproducing apparatus shown in FIG. 2 used a magnetic head 303 of a structure shown in FIG. 3.

Further, in the magnetic recording and reproducing apparatus in which each magnetic recording medium of Examples 4-1 to 4-8 and Comparative Examples 4-1 to 4-5 is assembled, a recording operation was performed under the condition that the track recording density is 1600 kFCI, the track density is 500 kFCI (surface recording medium is 800 Gbit/inch²), to measure the error rate (BER). The measurement result is shown in Table 5.

TABLE 5

| | Second magnetic layer | −Log (BER) |
|---|---|---|
| Example 4-1 | Co-8 at % Zr-6 at % Ta | 5.4 |
| Example 4-2 | Co-10 at % Zr-7 at % Ta | 6.2 |
| Example 4-3 | Co-15 at % Zr-10 at % Ta | 6.4 |
| Example 4-4 | Co-12 at % Zr-12 at % Ta | 6.7 |
| Example 4-5 | Co-12 at % Zr-14 at % Ta | 6.2 |
| Example 4-6 | Co-13 at % Zr-15 at % Ta | 6.5 |
| Example 4-7 | Co-14 at % Zr-16 at % Ta | 5.8 |
| Example 4-8 | Co-16 at % Zr-15 at % Ta | 5.2 |
| Comparative Example 4-1 | Co-4 at % Zr-5 at % Ta | 3.3 |
| Comparative Example 4-2 | Co-5 at % Zr-14 at % Ta | 3.8 |
| Comparative Example 4-3 | Co-10 at % Zr-4 at % Ta | 3.1 |
| Comparative Example 4-4 | Co-18 at % Zr-10 at % Ta | 3.4 |
| Comparative Example 4-5 | Co-12 at % Zr-18 at % Ta | 3.5 |
| Comparative Example 4-6 | Co-18 at % Zr-18 at % Ta | 3.0 |

As shown in Table 5, in the magnetic recording and reproducing apparatus in which each magnetic recording medium of Examples 4-1 to 4-8 is assembled, the error rate showed low values of 1×10⁻⁵ or lower. On the other hand, in the magnetic recording and reproducing apparatus in which each magnetic recording medium of Examples 4-1 to 4-6 is assembled, the error rate showed about 1×10⁻³.

Further, in the magnetic recording mediums of Examples 4-2 to 4-6 in which the sum of Zr and Ta contained in the second magnetic layer (CoZrTa) 208 is in the range of 16 to 28%, particularly, the error rate showed low values of 1×10⁻⁶ or lower.

Accordingly, it can be understood from the measurement result that the error rate is low in the magnetic recording and reproducing apparatus in which the magnetic recording medium of the present embodiment is assembled.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A magnetic recording medium having a structure in which at least an underlayer, a first magnetic layer and a second magnetic layer are sequentially stacked on a substrate,
wherein the first magnetic layer includes an alloy having an L1₀ structure as a main component, and
wherein the second magnetic layer includes a non-crystalline alloy containing Co as a main component and containing Zr of 6 to 16 atomic percent and at least one element of B and Ta.

2. The magnetic recording medium according to claim 1,
wherein the second magnetic layer includes a non-crystalline alloy of CoZrB, and B contained in the non-crystalline alloy is 6 to 16 atomic percent.

3. The magnetic recording medium according to claim 2,
wherein the sum of Zr and B contained in the non-crystalline alloy is 16 to 28 atomic percent.

4. The magnetic recording medium according to claim 1,
wherein the second magnetic layer includes a non-crystalline alloy of CoZrTa, and Ta contained in the non-crystalline alloy is 6 to 16 atomic percent.

5. The magnetic recording medium according to claim 4,
wherein the sum of Zr and Ta contained in the non-crystalline alloy is 16 to 28 atomic percent.

6. The magnetic recording medium according to claim 1,
wherein the first magnetic layer includes FePt or CoPt alloy having the L1₀ structure as the main component, and contains at least one or more of SiO₂, TiO₂, Cr₂O₃, Al₂O₃, Ta₂O₅, ZrO₂, Y₂O₃, CeO₂, MnO, TiO, ZnO, C, B₂O₃ and BN.

7. The magnetic recording medium according to claim 1,
wherein the first magnetic layer has a structure in which a lower magnetic layer that includes FePt alloy having the L1₀ structure as a main component and contains C and a upper magnetic layer that includes FePt alloy having the L1₀ structure as a main component and contains at least one or more of SiO₂, TiO₂, Cr₂O₃, Al₂O₃, Ta₂O₅, ZrO₂, Y₂O₃, CeO₂, MnO, TiO, ZnO, C, B₂O₃ and BN are sequentially stacked.

8. A magnetic recording and reproducing apparatus comprising:
the magnetic recording medium according to claim 1;
a medium driving unit that drives the magnetic recording medium in a recording direction;
a magnetic head that includes a laser generating unit that heats the magnetic recording medium and a wave guiding path that guides laser light generated in the laser generating unit to a tip end portion, and performs a recording operation and a reproducing operation with respect to the magnetic recording medium;
a head moving unit that relatively moves the magnetic head with respect to the magnetic recording medium; and
a recording and reproducing signal processing system that performs signal input to the magnetic head and reproduction of an output signal from the magnetic head.
